(19) United States
(12) Patent Application Publication
(10) Pub. No.: US 2014/0041001 A1
(43) Pub. Date: Feb. 6, 2014

(54) ELECTRONIC DEVICE AND METHOD FOR AUTOMATICALLY LOGGING-IN

(71) Applicant: HO-LEUNG CHEUNG, Santa Clara, CA (US)

(72) Inventor: HO-LEUNG CHEUNG, Santa Clara, CA (US)

(21) Appl. No.: 13/666,978

(22) Filed: Nov. 2, 2012

(30) Foreign Application Priority Data
Aug. 3, 2012 (TW) 101127906

(51) Int. Cl. H04L 9/32

(52) U.S. Cl. 726/7

(57) ABSTRACT

A method for automatically logging-in of an electronic device without repeatedly inputting user information is provided. The method includes receiving log-in information transmitted by a sensor placed within a predetermined range; verifying whether the log-in information matches user information stored in a storage unit according to a first table recording a relationship of the log-in information and the user information stored in the storage unit; and logging-in of the electronic device according to the user information corresponding to the log-in information when the log-in information matches the user information stored in the storage unit. The electronic device is also provided.

### BACKGROUND

1. Technical Field

The present disclosure relates to electronic devices and particularly to an electronic device and method for automatically logging-in.

2. Description of Related Art

A user usually inputs personal information (user name/password) to log-into an electronic device. However, in some occasions, the user need to repeatedly input the personal information, it is troublesome.

Therefore, it is desirable to provide an electronic device and a method for automatically logging-in, which can overcome the above-mentioned shortcomings.

### BRIEF DESCRIPTION OF THE DRAWINGS

FIG. 1 is a functional block diagram of an electronic device with function of automatically logging-in, according to a first embodiment.

FIG. 2 is a flowchart showing a method for automatically logging-into the electronic device of FIG. 1.

### DETAILED DESCRIPTION

Embodiments of the disclosure will be described with reference to the accompanying drawings.

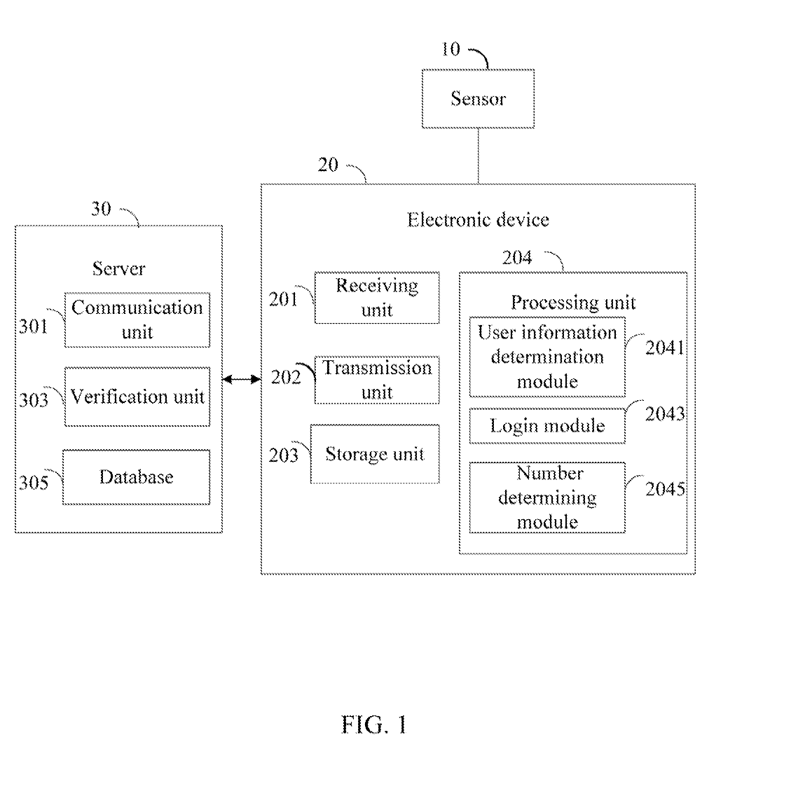

FIG. 1 is a functional block diagram of an electronic device with function of automatically logging-in. The electronic device 20 is connected with a sensor 10 and a server 30. The sensor 10 is a remote device which stores log-in information for logging-into the electronic device 20. Typically, the sensor 10 is NFC-enabled chip card. When a user wants to log-into the electronic device 20, the user places the sensor 10 within a predetermined range, the sensor 10 transmits the log-in information to the electronic device 20 in the predetermined range.

The electronic device 20 may be a computer or other electronic terminal with a network communication function. For example, the electronic device 20 may be a mobile phone. The server 30 is a network server, which is connected with the electronic device 20 through network. The electronic device 20 includes a receiving unit 201, a transmission unit 202, a storage unit 203, and a processing unit 204.

The receiving unit 201 receives the log-in information transmitted by the sensor 10. The transmission unit 202 sends data to the server 30. The storage unit 203 stores user information. The storage unit 203 stores a first table recording a relationship of the log-in information and the user information. Different log-in information corresponds to different user information.

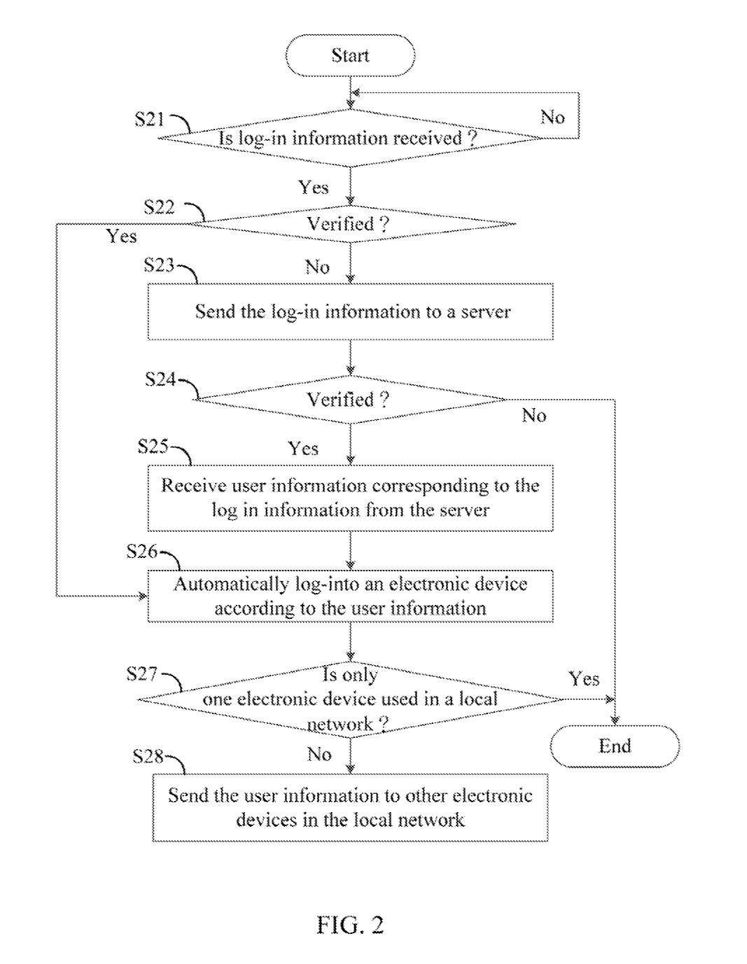

The processing unit 204 includes a user information determination module 2041, a login module 2043, and a number determining module 2045. Functions of the modules will be described together with FIG. 2.

The server 30 includes a communication unit 301, a verification unit 303, and a database 305. The communication unit 301 receives log-in information from the electronic device 20. The database 305 stores user information. The database 305 also stores a second table recording the relationship of log-in information and user information. The verification unit 303 verifies whether the log-in information matches the user information stored in the database 305. The communication unit 301 transmits the user information corresponding to the log-in information from the database 305 to the electronic device 20 when the log-in information matches the user information stored in the database 305. Functions of the server 30 will be described together with FIG. 2.

FIG. 2 is a flowchart showing a method for automatically logging-into the electronic device of FIG. 1.

In step S21, the receiving unit 201 determines whether the log-in information transmitted by the sensor 10 is received. If yes, the procedure goes to step S22, otherwise, the procedure repeats step S21.

In step S22, the user information determination module 2041 verifies whether the log-in information matches the user information stored in the storage unit 203 according to the first table.

If yes, the procedure goes to step S26, otherwise, the procedure returns to step S23.

In step S23, the transmission unit 202 sends the log-in information to the server 30.

In step S24, the communication unit 301 of the server 30 receives the log-in information, the verification unit 303 verifies whether the log-in information matches the user information stored in the database 305 according to the second table, if yes, the procedure goes to step S25, otherwise, the procedure ends.

In step S25, the communication unit 301 of the server 30 sends the user information corresponding to the log-in information to the electronic device 20, and the receiving unit 201 receives the user information from the communication unit 301 of the server 30 and stores the user information to the storage unit 203.

In step S26, the login module 2043 logs into the electronic device 20 according to the user information corresponding to the log-in information stored in the storage unit 203 or in the database 305.

In step S27, the number determining module 2045 determines a number of the electronic devices used in the local work thereby determining whether only one electronic device is used in a local network. If yes, the procedure ends, otherwise, the procedure goes to step S28.

In step S28, the transmission unit 202 sends the user information corresponding to the log-in information to other electronic devices 20 in the local network, thereby, the server 30 does not need to send the user information when needing to use other electronic devices 20.

The method above, the sensor 10 can allow the user to log-in the electronic device 20 according to the user information corresponding to the log-in information without repeatedly inputting the user information.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An electronic device with function of logging-in without repeatedly inputting user information, connected with a sensor storing log-in information, the electronic device comprising:
a receiving unit, to receive log-in information transmitted by the sensor placed within a predetermined range;
a storage unit, to store user information and a first table recording a relationship of the log-in information and the user information;
a processing unit, comprising:
a user information determining module, to verify whether the log-in information matches the user information stored in the storage unit according to the first table;
a logging module, to log-into the electronic device according to the user information corresponding to the log-in information when the log-in information matches the user information stored in the storage unit.

2. The electronic device according to claim 1, further comprising a transmission unit to send the log-in information to a server when the log-in information does not match the user information stored in the storage unit, wherein the server stores the user information and a second table recording a relationship of the log-in information and the user information, the receiving unit receives the user information corresponding to the log-in information sent by the server when the server verifies that the log-in information matches the user information stored in the server according to the second table.

3. The electronic device according to claim 2, wherein the receiving unit stores the user information corresponding to the log-in information sent by the server to the storage unit.

4. The electronic device according to claim 2, further comprising a number determining module to determine a number of the electronic devices used in a local work thereby determining whether only one electronic device is used in the local network, wherein the transmission unit sends the user information to other electronic devices when not only one electronic device is used in the local network.

5. The electronic device according to claim 2, wherein the electronic device is an electronic terminal with a network communication function.

6. A method for automatically logging-in of an electronic device without repeatedly inputting user information, comprising:
receiving log-in information transmitted by a sensor placed within a predetermined range;
verifying whether the log-in information matches user information stored in a storage unit according to a first table recording a relationship of the log-in information and the user information stored in the storage unit; and
logging-in of the electronic device according to the user information corresponding to the log-in information when the log-in information matches the user information stored in the storage unit.

7. The method according to claim 6, further comprising:
sending the log-in information to a server when the log-in information does not match the user information stored in the storage unit; and
receiving the user information corresponding to the log-in information sent by a server when the log-in information matches the user information stored in the server according to a second table recording a relationship of the log-in information stored in the server.

8. The method according to claim 7, further comprising:
storing the user information corresponding to the log-in information sent by the server to the storage unit.

9. The method according to claim 7, further comprising determining a number of the electronic devices used in a local work thereby determining whether only one electronic device is used in the local network, and sending the user information to other electronic devices when not only one electronic device is used in the local network.

10. The method according to claim 6, wherein the electronic device is an electronic terminal with a network communication function.

11. The method according to claim 6, wherein the sensor is a remote device which stores the log-in information for logging-into the electronic device.

12. The method according to claim 6, wherein the sensor is NFC-enabled chip card.
